(19) United States
(12) Patent Application Publication
(10) Pub. No.: US 2005/0156779 A1
(43) Pub. Date: Jul. 21, 2005

(54) Pulse radar device and method for registering, detecting and/or evaluating at least one object

(76) Inventor: Thomas Wixforth, Langenberg (DE)

Correspondence Address: Striker Striker & Stenby, 103 East Neck Road, Huntington, NY, 11743, US

(21) Appl. No.: 10/503,856

(22) PCT Filed: Dec. 11, 2002
(86) PCT No.: PCT/DE02/04537

(30) Foreign Application Priority Data
Feb. 27, 2002 (DE) 19208332.0

(51) Int. Cl. G01S 13/42

(52) U.S. Cl. 342/70; 342/71; 342/194; 342/107; 342/113; 342/146; 342/134

(57) ABSTRACT

In order to be able to further develop a pulse radar apparatus (100) and method for acquiring, detecting, and/or evaluating at least one object so that data can be obtained not only about the distance to the object, but also with regard to the angular position of the object to be detected, the invention has proposed that
the receiving antenna unit (30) of the pulse radar apparatus (100) be embodied
as a group antenna that has at least two antenna elements (32, 34, 36, 38) and is designed to receive the signals reflected against the object as vectorial signals and
that the reception branch (50) of the pulse radar apparatus (100) be followed by at least one receiving circuit (70), in particular an LF (low-frequency) receiving circuit, for evaluating and processing the received vectorial signals so that it is also possible to measure and determine the angular position of the at least one object.

### TECHNICAL FIELD

The current invention relates to a pulse radar apparatus for acquisition, detection, and/or evaluation of at least one object, having
[a] at least one oscillator unit, in particular a microwave oscillator unit, for generating oscillator signals;
[b] at least one transmission branch connected after the oscillator unit, with
[b.1] at least one emitted pulse switch unit, which can be acted on by the oscillator signals and is for generating pulse-modulated high-frequency signals, and
[b.2] at least one transmitting antenna unit, which is connected after the emitted pulse switch unit and is for emitting the high-frequency signals generated by the emitted pulse switch unit;
[c] at least one reception branch, in particular an RF (radio frequency) branch, connected after the oscillator unit, with
[c.1] at least one receiving antenna unit for receiving the signals reflected against the object,
[c.2] at least one received pulse switch unit connected after the receiving antenna unit, and
[c.3] at least one I/Q (inphase/quadrature) mixing unit that is connected after the receiving antenna unit and is for mixing
[c.3.1] the signals, which are received by the receiving antenna unit and can act on the first input connection of the I/Q mixing unit,
[c.3.2] with the oscillator signals, which can act on the second input connection of the respective I/Q mixing unit;
[d] at least one clock-pulse generator unit, in particular an LF (low-frequency) clock-pulse generator unit for generating clock signals that can act on both the emitted pulse switch unit and on the received pulse switch unit; and
[e] at least one pulse delay unit that is connected between the clock-pulse generator unit and the received pulse switch unit and is for executing a defined time delay of the clock signals, which trigger the received pulse switch unit, in relation to the clock signals, which trigger the emitted pulse switch unit.

The current invention also relates to a method for acquisition, detection, and/or evaluation of at least one object, in which method
oscillator signals are generated by means of at least one oscillator unit, in particular a microwave oscillator unit;
pulse-modulated high-frequency signals are generated by means of at least one emitted pulse switch unit, which can be acted on by the oscillator signals;
the high-frequency signals generated by the emitted pulse switch unit are emitted by at least one transmitting antenna unit, which is connected after the emitted pulse switch unit;
the signals reflected against the object are received by at least one receiving antenna unit;
the signals received by the receiving antenna unit, which can act on the first input connection of at least one I/Q (inphase quadrature) mixing unit connected after the receiving antenna unit, and the oscillator signals, which can act on the second input connection of the respective I/Q mixing unit, are mixed by means of the respective I/Q mixing unit;
clock signals, which can act on both the emitted pulse switch unit and on at least one received pulse switch unit connected after the receiving antenna unit, are generated by at least one clock-pulse generator unit, in particular an LF (low-frequency) clock-pulse generator unit; and
at least one pulse delay unit, which is connected between the clock-pulse generator unit and the received pulse switch unit, executes a defined time delay of the clock signals, which trigger the received pulse switch unit, in relation to the clock signals, which trigger the emitted pulse switch unit.

### PRIOR ART

A sensing of the environment of a means of locomotion, in particular a motor vehicle, can basically be executed by means of LIDAR (light detecting and ranging), RADAR (radio detecting and ranging), video, or ultrasound.

German Patent Disclosure 42 42 700 A1 has thus disclosed an object detection system with microwave radar sensor, which makes it possible to detect objects, in particular even those traveling a great distance in front of a vehicle. This radar sensor contributes to a vehicle safety system that continuously processes data about the distance and relative speed of the vehicle in relation to the vehicles traveling ahead of it within a predetermined angular range.

German Patent Disclosure 44 42 189 A1 has disclosed that in a system for distance measurement in the environment of motor vehicles, sensors can be used, which have both transmitter units and receiver units for simultaneously sending and receiving data. In this case, the distance measurement can also be used to activate passive protective measures for the motor vehicle, for example in the event of a front, side, or rear-end collision. With an exchange of the data acquired, traffic situations, for example, can be assessed in order to activate appropriate triggering systems.

Furthermore, German Patent Disclosure 196 16 038 A1 has also disclosed an object detection system in which an optical transmitter is provided for a light beam with a changing transmission angle and an angle-resolving optical receiver. The emitted light beam here is modulated in such a way that the phase difference between the emitted light beam and the received light beam can also be used, up to a certain distance, to determine the position of the object within the angular range of the emitted light beam.

German Patent Disclosure 196 22 777 A1 has disclosed a sensor system for automatic relative position determination between two objects. This conventional sensor system is comprised of a combination of an angle-independent sensor and an angle-dependent sensor. The sensor, which is not angle-resolving and is therefore angle-independent, is embodied as a sensor that evaluates the distance to an object by measuring a transmission time. Radar, lidar, or ultrasound sensors are proposed as possible sensors.

The angle-dependent sensor is comprised of a geometric arrangement of optoelectronic transmitters and receivers that are arranged in the form of light barriers. The sensors, which both cover a shared detection region, are disposed in close spatial proximity to each other. In order to determine a relative position in relation to the object, the angle-independent sensor determines the distance to the object and the angle-resolving sensor determines the angle in relation to the object.

Knowing the distance and angle in relation to the object makes it possible to calculate the relative position in relation to the object. As an alternative to the above-mentioned arrangement of optoelectronic transmitters and receivers, the use of two sensors is proposed, which jointly determine the angle in relation to the object by means of the triangulation principle.

German Patent Disclosure 199 49 409 A1 has disclosed a method and device for object detection with at least two distance-resolving sensors, which are mounted to a motor vehicle and whose detection ranges at least partially overlap. In this case, means are provided for determining the relative position of possibly detected objects in relation to the sensors in the overlap region by means of the triangulation principle; apparent objects possibly generated by the object identification can be detected by means of dynamic object observations.

Finally, German Patent Disclosure 100 11 263 A1 has proposed an object detection system particularly intended for a motor vehicle in which the object detection system has a number of object detectors and/or operating modes that permits acquisition in different detection ranges and/or detection regions. In this connection, an object detector can be a radar sensor that, in a first operating mode, has a relatively large detection range with a relatively small angular detection region and in a second operating mode, has a relatively small detection range with an increased angular detection region.

Considered in and of itself, it is generally known that a distance measurement can be executed with a so-called pulse radar in which a carrier pulse is transmitted, which has a rectangular envelope of an electromagnetic oscillation in the gigahertz range.

This carrier pulse is reflected against the target object and the distance to the target can be determined based on the interval between the transmission of the pulse and the arrival of the reflected radiation and, within limits, the relative speed of the target object can be determined through use of the Doppler effect. Such a measurement principle is described, for example, in the technical text “Handbook of Radar and Radar Signal Processing” [Handbuch Radar und Radarsignalverarbeitung] by Albrecht Ludloff, pp. 2-21 to 2-44, Vieweg-Verlag 1993.

Reliable triggering of the above-mentioned passenger protection systems in a motor vehicle generally requires a large number of radar sensors for the individual conflict situations in the environment of the vehicle; for example, it is necessary to provide an early collision detection (so-called pre-crash detection) in order to permit early detection of an object that represents a danger to vehicle passengers in the event of a collision. This is intended to permit safety systems such as airbags, safety belt tensioners, or side airbags to be punctually activated in order for them to achieve the greatest possible protective action.

The detection and monitoring of the traffic situation, particularly in the immediate vicinity of the motor vehicle, can also be useful in numerous other applications. These include parking aids, assisting devices for monitoring the so-called “blind spot”, and means for easing the task of driving in so-called “stop and go” traffic in which the distance to the vehicle in front is determined in order to permit automatic stopping and starting.

Usually a multitude of radar sensors are used for this, with different requirements adapted to the respective measurement tasks; the requirements essentially differ in the range and the evaluation time because each of these functions has specific detection regions and different measuring cycle times; although in principle, so-called universal sensors can in fact be operated together by means of a specially adapted bus system and connected to one another by means of an evaluation unit, it is often the case that due to processing power limitations, not all distance ranges within a close range are optimally processed within the relatively short evaluation time required for a reliable function.

For this reason, German Patent Disclosure 199 63 005 A1 has proposed a device and method for detecting and evaluating objects in the environment of a motor vehicle according to the preamble to the independent claim.

According to German Patent Disclosure 199 63 005 A1, the environment of the motor vehicle is detected by using a transmission signal of a pulse radar sensor in one or more receiver branches in such a way that different distance ranges are evaluated in parallel and/or in sequence; however neither the device nor the method according to German Patent Disclosure 199 63 005 A1 is in a position to also supply corresponding angle data with regard to the detected object.

### DEPICTION OF THE INVENTION: OBJECT, ATTAINMENT, AND ADVANTAGES

In view of the above-mentioned disadvantages and insufficiencies and in view of the outlined prior art, the object of the current invention is to further develop a pulse radar apparatus of the type mentioned at the beginning as well as a method of the type mentioned at the beginning so that data can be obtained not only about the distance, but also about the angular position of an object to be detected.

This object is attained by means of a pulse radar apparatus with the features disclosed in claim 1 and by means of a method with the features disclosed in claim 7. Advantageous embodiments and useful modifications of the current invention are disclosed in the relevant dependent claims.

The teaching according to the current invention accordingly builds on the conventional radar concept and on the conventional state of development that permits distance measurement of targets to be detected and sensed by means of 24 GHz close-range radar techniques and supplements these not only by means of additional reception channels or paths, but also by means of at least one (receiving) group antenna in order to constitute a sensor group.

This at least one group antenna, through the use of digital signal processing methods, permits
beam shaping of antenna directivity patterns,
angular measurements of detected target objects, and
so-called DOA (direction of arrival) algorithms in combination with the pulse operation and consequently obtains considerably more precise data about the vehicle environment being sensed.

In this connection, there can also be a simultaneous reduction in the required number of radar sensors and installation positions per motor vehicle, thus reducing the overall cost of the close-range radar system; the use of at least one group antenna in the receiver branch opens up considerable innovation potential in the field of radar sensors and offers an intelligent, reasonably priced combination of analog and digital signal processing.

In general, this yields a group antenna of the kind that is known, for example, from German Patent Disclosure 195 35 441 A1 and is comprised of the interconnection of a number of individual antennas. Through the complex weighting of the individual antenna paths, for example a directivity characteristic of the overall arrangement can be obtained, with a sharply pronounced main lobe in the desired direction; furthermore, zeroes can also be generated in the directivity pattern in order to suppress different interference signals in a directionally selective manner.

For reception with a group antenna, the directivity of the group antenna can be continuously adapted to the current properties of the transmission channel; this is also referred to as an adapted antenna system or an intelligent antenna (a so-called “smart antenna”). The adaptation is executed by means of algorithms that determine the most optimal possible set of weighting factors based on the signal values received.

The selection of a suitable algorithm here essentially depends on
the concrete properties of the transmission channel,
the concrete properties of the group antenna,
the available processing power of the digital signal processing unit,
the required precision, and
the insensitivity to error influences.

In connection with the current invention, a specialist in the field of object detection by means of distance-resolving sensors will especially appreciate the fact that the use of several antenna elements belonging to the group antenna, whose respectively received data can be transported on a number of associated reception channels or paths and processed not least based on the phase shift of the signals in relation to one another, makes it possible to obtain angular data and from it, also a directional estimate by means of a single sensor. Moreover, the design proposed according to the invention involves a very little additional complexity and therefore very slight additional costs.

Finally, the current invention relates to the use of at least one pulse radar apparatus of the above-mentioned type and/or a method of the above-mentioned type in the field of motor vehicle environment sensing technology, for example to measure and determine the angular position of at least one object, as is relevant, for example, in the context of pre-crash sensing in a motor vehicle.

In this case, a sensor system determines whether there is the possibility of a collision with the detected object, for example another motor vehicle. If a collision is about to occur, an additional determination is made as to the speed and impact point at which the collision will occur. Knowing these data can gain life-saving milliseconds for the driver of the motor vehicle in which preparatory measures can be taken, for example the triggering of the airbag or a safety belt tensioning system.

Other possible application areas of the system and method according to the current invention include parking assistance systems, blind spot detection, or a stop and go system as a modification to of an existing device for automatically regulating vehicle speed, for example an ACC (adaptive cruise control) system.

### BRIEF DESCRIPTION OF THE DRAWINGS

Other embodiments, features, and advantages of the current invention will be explained in detail below in conjunction with the three exemplary embodiments shown in FIGS. 1 to 3.

FIG. 1 is a schematic depiction of a first exemplary embodiment of the pulse radar apparatus according to the current invention;

FIG. 2 is a schematic depiction of a second exemplary embodiment of the pulse radar apparatus according to the current invention; and

FIG. 3 is a schematic depiction of a third exemplary embodiment of the pulse radar apparatus according to the current invention.

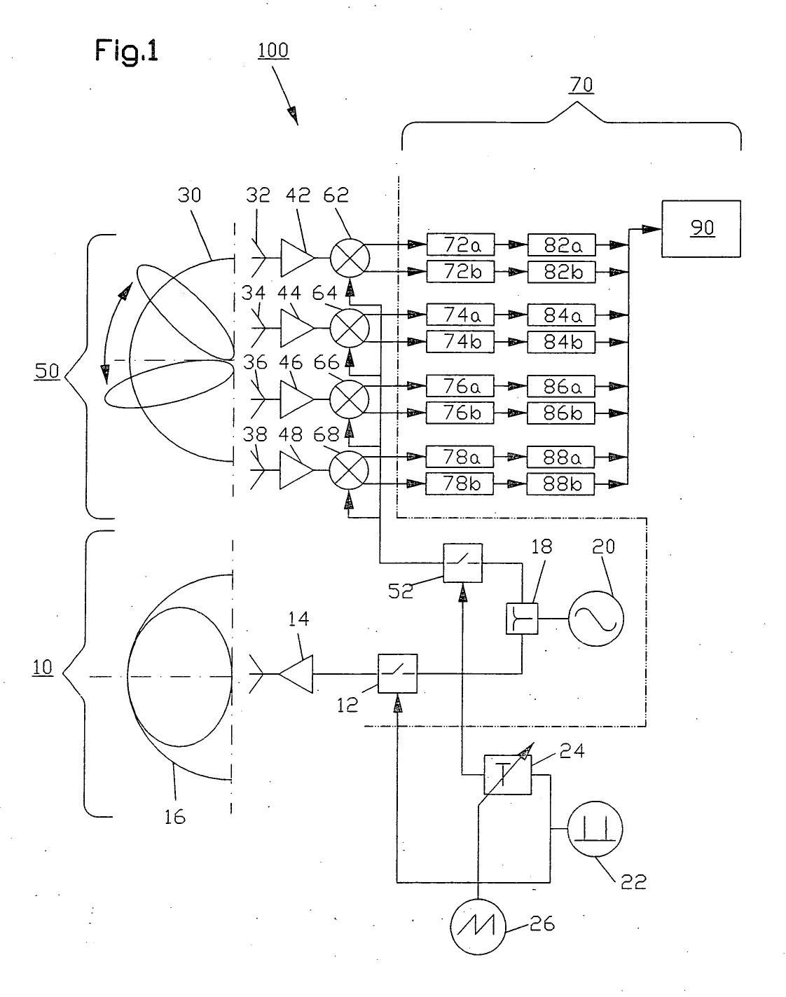

Embodiments, elements, or features that are the same or similar are provided with identical reference numerals in FIGS. 1 to 3.

### BEST WAY TO EMBODY THE INVENTION

By way of example, the text below will explain the close range-designed pulse radar apparatus 100 according to the current invention and a method associated with it for acquiring, detecting, and/or evaluating at least one object. In the three exemplary embodiments shown, the boundary between the HF (high-frequency) range (the so-called “RF (radio frequency)”) in the left half of the drawings in FIGS. 1, 2, and 3 and the LF (low-frequency) range in the right half of the drawings in FIGS. 1, 2, and 3 is represented by a dot-and-dash line.

FIG. 1 shows a first exemplary embodiment of the pulse radar apparatus 100 in which a microwave oscillator unit 20 (a so-called “24 GHz microwave front end” according to an oscillation period of approx. 41.67 picoseconds or a wavelength of approx. 12.5 millimeters) generates oscillator signals in the form of pulses with a pulse duration of approx. four hundredths of a picosecond (corresponding to a frequency of approx. 2.5 gigahertz or a wavelength of approx. twelve centimeters) and amplitude modulates them on a 24.125 gigahertz carrier.

A pulse therefore contains approx. ten pulse trains of the 24 GHz carrier (oscillation period of approx. forty picoseconds) and is approx. the length of ten wavelengths of the carrier, namely approx. 12.5 centimeters long, which indicates the order of magnitude of the achievable distance resolution; step-recovery diodes are used to generate the short pulses.

On the transmission side, the pulses control an emitted pulse switch unit 12 in the form of a microwave switch that amplitude-modulates the carrier (so-called “on-off keying”). The sidebands of the modulation spectrum have their first zeroes (400 ps)⁻=2.5 GHz away from the carrier. The pulse repetition frequency is approx. five megahertz, which corresponds to an oscillation duration or time delay of approx. 200 nanoseconds and consequently corresponds to approx. sixty meters of pulse travel; unambiguous distance measurements are therefore possible up to a maximum of approx. thirty meters.

The transmission pulses thus formed are conveyed to a transmission amplifier unit 14 in the form of an amplifying transistor and are then conveyed to a transmitting antenna element 16, which emits the high-frequency signals generated by the emitted pulse switch unit 12 and produces a wide antenna directivity diagram (so-called “antenna pattern”) in order to have a large region of angular coverage. The pulses reflected by the target objects are then received by a receiving antenna unit 30, which is separate so as to facilitate decoupling, and are conveyed to a receiving amplifier.

According to the teaching of the current invention, FIG. 1 shows an example of a receiving antenna unit 30 in the form of a group antenna with four antenna elements 32, 34, 36, 38 (however two, three, five, or more antenna elements can also be provided).

According to the invention, for each antenna element 32, 34, 36, 38, a separate receiver channel or path is provided, having
a respective receiving amplifier 42, 44, 46, 48 in the form of a so-called LNA (low noise amplifier), for example having one or two respective RF (radio frequency) transistor units,
a respective I/Q (inphase/quadrature) mixer 62, 64, 66, 68, for example each having four RF (radio frequency) diode units,
two respective low pass filters 72a, 72b, 74a, 74b, 76a, 76b, 78a, 78b with base band amplifiers and with impedance conversion, for example each having an LF (low-frequency) transistor unit with the accompanying filter, and
two respective A/D (analog/digital) converters 82a, 82b, 84a, 84b, 86a, 86b, 88a, 88b, preferably situated inside at least one microcontroller.

As can be inferred from FIG. 1, a power divider 18, which functions in as symmetrical a fashion as possible, now triggers and powers the respective LO (local oscillator) gate of all of the I/Q mixers 62, 64, 66, 68 with pulsed, repeating LO (local oscillator) signals of equal amplitudes and equal time durations, with a time delay that can be set by means of a pulse delay unit 24. Just like the other pulses, these LO pulses are generated on the transmission side.

If the time delay of these LO pulses, which is set by the pulse delay unit 24, now corresponds to the travel time of the emitted pulse that has been reflected against a target object, then the signal energy of the base band signals of the received pulses at the output connection of the I/Q mixers 62, 64, 66, 68 will be at a maximum (so-called “local maximum”); in other words, the received pulses pass through a matched filter, so to speak, in the time domain. Since this matched filter executes a chronological windowing, so to speak, on the reception side, it also filters out undesirable noise and thus optimizes the signal-to-noise efficiency ratio after the I/Q mixers 62, 64, 66, 68.

The time delay, which is proportional to the distance from the target object, is varied between zero and approx. 200 nanoseconds—only at a slow rate in comparison to the pulse repetition frequency of five megahertz produced by the microwave oscillator unit 20—namely by means of at least one variation oscillator unit 26 associated with the pulse delay unit 24, at a frequency of approximately one hundred hertz (corresponding to an oscillation period of approx. ten milliseconds) and preferably with a saw tooth pattern; the matched filter therefore represents a time domain window in a manner of speaking, which is shifted over the range of distances to the target object by means of the saw tooth signal of the variation oscillator unit 26.

This means that the matched filter or “target window” is situated over a target for more than one pulse and that the signal energies of several pulses associated with a target are integrated through a subsequent low pass filtration by means of the low pass filter units 72a, 72b, 74a, 74b, 76a, 76b, 78a, 78b, which improves the signal-to-noise efficiency ratio and therefore significantly increases the probability of an exact target detection; moreover, the low pass filters 72a, 72b, 74a, 74b, 76a, 76b, 78a, 78b significantly narrow the bandwidth of the received analog signals in relation to the broad-band pulse signals.

The threshold frequency of the respective pair of low pass filters 72a, 72b; 74a, 74b; 76a, 76b; 78a, 78b provided for each of the four RF (radio frequency) reception channels or paths, for the I (inphase) components of the base band signals and for the Q (quadrature) components of the base band signals, limits the target distance resolution that can still be derived after the respective low pass filter 72a, 72b, 74a, 74b, 76a, 76b, 78a, 78b and is therefore approximately one hundred times one hundred hertz.

Therefore, a relatively low scan rate, namely from approx. twenty kilohertz to approx. forty kilohertz, of the A/D (analog/digital) converters 82a, 82b, 84a, 84b, 86a, 86b, 88a, 88b, which scan the base band signals and will be explained in more detail below, is sufficient for a further digital signal processing and evaluation in a microprocessor 90.

The threshold frequency of the low pass filters 72a, 72b, 74a, 74b, 76a, 76b, 78a, 78b also limits the maximum Doppler frequency of the base band pulses produced when target objects are moving radially in relation to the radar and consequently also limits the maximum radial relative speed of detectable target objects.

In the A/D converters 82a, 82b, 84a, 84b, 86a, 86b, 88a, 88b, which are connected after the low pass filters 72a, 72b, 74a, 74b, 76a, 76b, 78a, 78b and operate at least essentially in parallel, the scan times must all be the same or must at least be in a fixed time raster in relation to one another so as to assure a coherent processing of the signals of the antenna elements 32, 34, 36, 38 inside the receiving circuit 70, which is embodied as a set of LF (low-frequency) electronics (in this connection, “LF (low-frequency) electronics” means low pass frequencies and scanning frequencies on the order of a few kilohertz).

Vectorial, complex-valued base band signals are consequently available on the digital side of the A/D converters 82a, 82b, 84a, 84b, 86a, 86b, 88a, 88b and digital signal processing methods for antenna pattern beam-shaping (<--> spatial filtration), angle estimation methods, and the like can then be used on these signals.

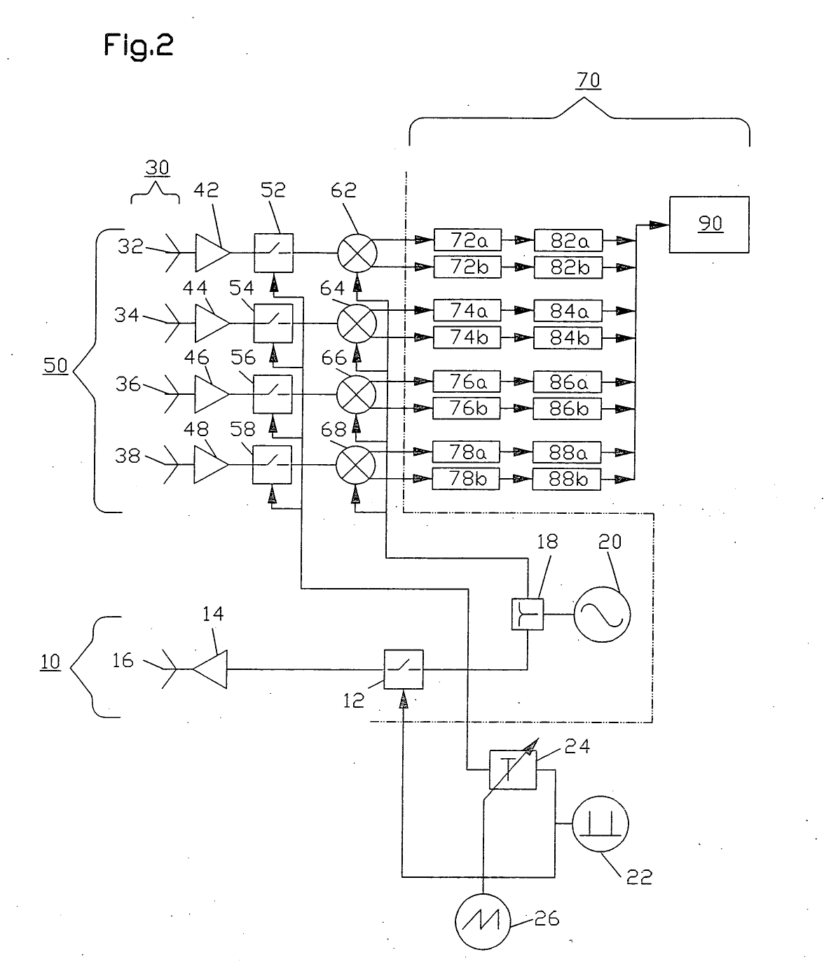

FIG. 2 shows a second exemplary embodiment of the pulse radar apparatus 100, which represents a variation of the first exemplary embodiment from FIG. 1; for this reason, only the differences in relation to the first exemplary embodiment will be discussed below in order to avoid unnecessary repetition.

According to FIG. 2, the reception-side pulse switches 52, 54, 56, 58 are instead disposed in the LO (local oscillator) branch of the I/Q mixers 62, 64, 66, 68, in the RF (radio frequency) reception branch 50, after the respective antenna elements 32, 34, 36, 38, after the respective receiving amplifiers 42, 44, 46, 48, and before the respective I/Q mixers 62, 64, 66, 68.

This second exemplary embodiment does in fact require four received pulse switch units 52, 54, 56, 58 (the first exemplary embodiment according to FIG. 1 requires only one received pulse switch unit 52), but this offers advantages with regard to power considerations, not least because the respective second input connection of each of the four I/Q mixers 62, 64, 66, 68 is powered by the oscillator signal of the microwave oscillator unit 20 directly (and not, as in the first exemplary embodiment according to FIG. 1, via the sole received pulse switch unit 52 that it contains).

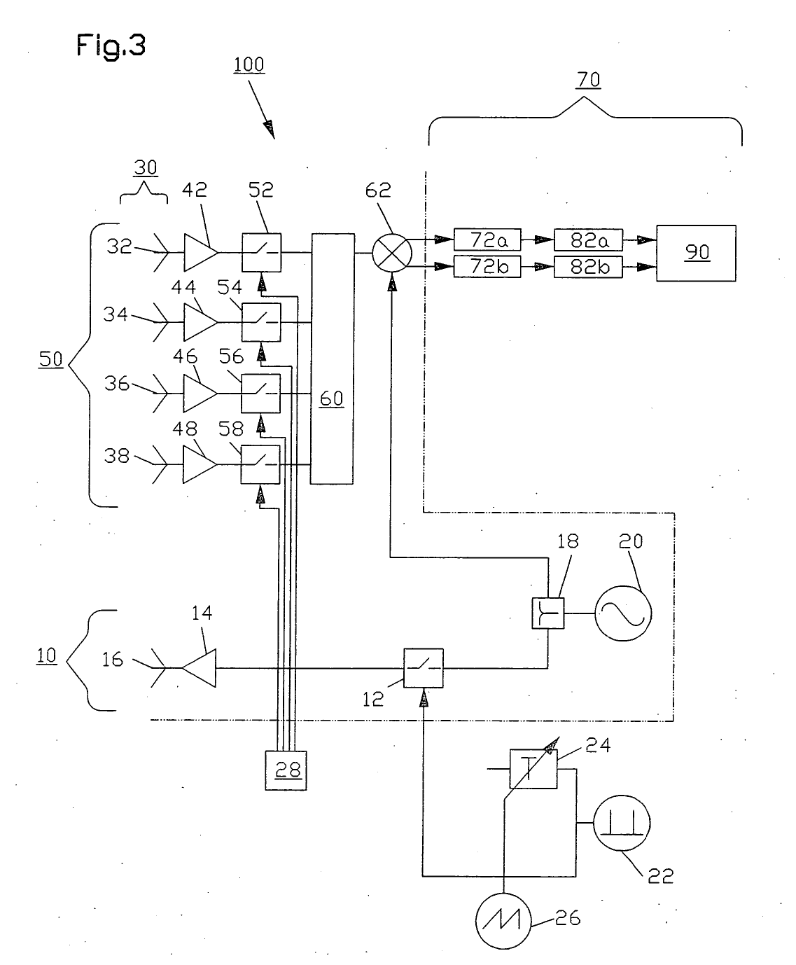

According to a third exemplary embodiment of the pulse radar apparatus 100 shown in FIG. 3, the received pulse switch units 52, 54, 56, 58 of the four reception channels or paths can be selectively or optionally triggered
preferably individually, in chronological order and
preferably time-delayed in a manner that can be set by means of the pulse delay unit 24,
   which is made possible in FIG. 3 through the addition of an MX (multiplex) unit 28, which can connect the 5 MHz pulses of the LF (low-frequency) clock-pulse generator unit 22 to any one of the four different reception channels or paths.

In the wiring diagram in FIG. 3, the respective output signals from the output connections of the received pulse switch units 52, 54, 56, 58 are combined by means of an HF (high-frequency) power divider/combiner 60 (a so-called “HF (high-frequency) divider/combiner”) and conveyed to the single inphase/quadrature mixer 62, which is connected after the HF (high-frequency) power divider/combiner 60 and whose second input connection is once again powered by the oscillator signal of the microwave oscillator unit 20 directly (and not, as in the first exemplary embodiment according to FIG. 1, via the received pulse switch unit 52).

For the digital signal processing in this instance according to FIG. 3, there is thus only one complex-valued scalar available at a time and not, as in FIGS. 1 and 2, a complex-valued vector. Correspondingly, the signals of the four different antenna elements 32, 34, 36, 38 in the third exemplary embodiment according to FIG. 3 are sequential, i.e. are received in chronological order (and not simultaneously) by the digital signal processing unit 90, which is accompanied by a significant reduction in the cost of the circuitry in FIG. 3.

A requirement for the proper function of the circuit technique according to FIG. 3 is that the chronologically sequential reception of the individual element signals occurs more rapidly than the changes in the signal situation of the sensor field. This sometimes involves a higher cost for the A/D converters 82a, 82b, 84a, 84b, 86a, 86b, 88a, 88b and the digital signal processing unit 90 in order to achieve higher scan rates or higher processing speeds than the circuit arrangements according to FIGS. 1 and 2.

As a result, in the third exemplary embodiment of the pulse radar apparatus 100, the selective triggering, preferably individually and in chronological order, of the received pulse switch units 52, 54, 56, 58 in the manner according to the invention achieves a selective scanning of the reception signals of the antenna elements 32, 34, 36, 38 of the reception group antenna 30.

This scanning occurs significantly faster than changes in the signal or object situation in the field being sensed, so that based on the complex-valued individual signals, which can be associated with the four antenna elements 32, 34, 36, 38 and are conveyed to the processor 90, a complex-valued signal vector can be reconstructed for the digital signal processing in the processor 90.

The three exemplary embodiments described above can be changed, particularly with regard to the number of their reception channels or branches and with regard to the shared or separately utilized receiver components, without significantly changing the function according to the current invention.

It is also possible to provide a combination of parallel and sequential evaluation of the different distance and/or angle ranges that differs from the three exemplary embodiments shown. Furthermore, under certain circumstances, the evaluation of the data from the different distance ranges does not require all distance data to be queried in order to save measuring time due to the drop in processing power when calculating to a power of four; in this connection, however, the distance data should be checked continuously until the first relevant change.

1. A pulse radar apparatus (100) for acquisition, detection, and/or evaluation of at least one object, having
[a] at least one oscillator unit (20), in particular a microwave oscillator unit, for generating oscillator signals;
[b] at least one transmission branch (10) connected after the oscillator unit (20), with
[b.1] at least one emitted pulse switch unit (12), which can be acted on by the oscillator signals and is for generating pulse-modulated high-frequency signals, and
[b.2] at least one transmitting antenna unit (16), which is connected after the emitted pulse switch unit (12) and is for emitting the high-frequency signals generated by the emitted pulse switch unit (12);
[c] at least one reception branch (50), in particular an RF (radio frequency) branch, connected after the oscillator unit (20), with
[c.1] at least one receiving antenna unit (30) for receiving the signals reflected against the object,
[c.2] at least one received pulse switch unit (52, 54, 56, 58) connected after the receiving antenna unit (30), and
[c.3] at least one I/Q (inphase/quadrature) mixing unit (62, 64, 66, 68) that is connected after the receiving antenna unit (30) and is for mixing
[c.3.1] the signals, which are received by the receiving antenna unit (30) and can act on the first input connection of the I/Q mixing unit (62, 64, 66, 68),
[c.3.2] with the oscillator signals, which can act on the second input connection of the respective I/Q mixing unit (62, 64, 66, 68);
[d] at least one clock-pulse generator unit (22), in particular an LF (low-frequency) clock-pulse generator unit, for generating clock signals that can act on both the emitted pulse switch unit (12) and on the received pulse switch unit (52, 54, 56, 58); and
[e] at least one pulse delay unit (24) that is connected between the clock-pulse generator unit (22) and the received pulse switch unit (52, 54, 56, 58) and is for executing a defined time delay of the clock signals, which trigger the received pulse switch unit (52, 54, 56, 58), in relation to the clock signals, which trigger the emitted pulse switch unit (12),
characterized in that
the receiving antenna unit (30) is embodied
as at least one group antenna that has at least two antenna elements (32, 34, 36, 38) and
is designed to receive the signals reflected against the object as vectorial signals and that
the reception branch (50) is followed by at least one receiving circuit (70), in particular an LF (low-frequency) receiving circuit, for evaluating and processing the received vectorial signals so that it is also possible to measure and determine the angular position of the at least one object.

2. The pulse radar apparatus according to claim 1, characterized in that the oscillator unit (20) is followed by at least one power divider unit (18), which can distribute the oscillator signals generated by the oscillator unit (20) to the transmission branch (10) and the reception branch (50).

3. The pulse radar apparatus according to claim 1, characterized in that
the transmitting antenna unit (10) is preceded by at least one transmission amplifier unit (14) for amplifying the emitted high-frequency signals and/or that
the antenna elements (32, 34, 36, 38) of the group antenna are each followed by at least one reception amplifier unit (42, 44, 46, 48) for amplifying the signals received by the respective antenna element (32, 34, 36, 38).

4. The pulse radar apparatus according to claim 1, characterized in that the receiving circuit (70) has:
at least one low pass filter unit (72a, 74a, 76a, 78a) connected after the I (inphase) output connection of the I/Q mixing unit (62, 64, 66, 68) and
at least one low pass filter unit (72b, 74b, 76b, 78b) connected after the Q (quadrature) output connection of the I/Q mixing unit (62, 64, 66, 68), which low pass filter units (72a, 72b, 74a, 74b, 76a, 76b, 78a, 78b) are provided to filter and/or to integrate, and in particular to narrow the bandwidth of the analog broadband signals received;
at least one A/D (analog/digital) converter unit (82a, 82b, 84a, 84b, 86a, 86b, 88a, 88b), which is connected after the respective low pass filter unit (72a, 72b, 74a, 74b, 76a, 76b, 78a, 78b) and serves to convert the low pass-filtered analog signals with a relatively low scan rate into digital signals; and
at least one processor unit (90) connected after the AND converter units (82a, 82b, 84a, 84b, 86a, 86b, 88a, 88b), in particular a microprocessor unit, for digitally processing the digital signals, which are systematized in the form of complex-valued vectors or complex-valued scalars.

5. The pulse radar apparatus according to claim 1, characterized in that
the received pulse switch unit (52, 54, 56, 58) is disposed between the oscillator unit (20) and the respective I/Q mixing units (62, 64, 66, 68), or that
the respective received pulse switch unit (52, 54, 56, 58) is connected between the respective antenna element (32, 34, 36, 38) and the respective I/Q mixing unit (62, 64, 66, 68).

6. The pulse radar apparatus according to at claim 1, characterized in that
between the pulse delay unit (24) and the respective received pulse switch unit (52, 54, 56, 58), at least one MX (multiplex) unit (28) is provided for selectively triggering, preferably offset to one another in chronological order, the respective received pulse switch units (52, 54, 56, 58) with the chronologically delayed clock signals, and that
between the respective received pulse switch unit (52, 54, 56, 58) and the I/Q mixing unit (62), there is at least one power combiner unit (60), in particular an HF (high-frequency) power divider/combiner unit, for producing complex-valued scalars for the digital signal processing.

7. A method for acquisition, detection, and/or evaluation of at least one object, in which method oscillator signals are generated by means of at least one oscillator unit (22), in particular a microwave oscillator unit;
pulse-modulated high-frequency signals are generated by means of at least one emitted pulse switch unit (12) that can be acted on by the oscillator signals;
the high-frequency signals generated by the emitted pulse switch unit (12) are emitted by at least one transmitting antenna unit (16) that is connected after the emitted pulse switch unit (12);
the signals reflected against the object are received by at least one receiving antenna unit (30);
the signals, which are received by the receiving antenna unit (30) and can act on the first input connection of at least one I/Q (inphase quadrature) mixing unit (62, 64, 66, 68) connected after the receiving antenna unit (30), and the oscillator signals, which can act on the second input connection of the respective I/Q mixing unit, are mixed by means of the respective I/Q mixing unit (62, 64, 66, 68);
clock signals that can act on both the emitted pulse switch unit (12) and on at least one received pulse switch unit (52, 54, 56, 58) connected after the receiving antenna unit (30), are generated by at least one clock-pulse generator unit (22), in particular an LF (low-frequency) clock-pulse generator unit; and
at least one pulse delay unit (24) that is connected between the clock-pulse generator unit (22) and the received pulse switch unit (52, 54, 56, 58) executes a defined time delay of the clock signals, which trigger the received pulse switch unit (52, 54, 56, 58), in relation to the clock signals, which trigger the emitted pulse switch unit (12),
characterized in that
the signals reflected against the object are received as vectorial signals by means of at least one group antenna, which has at least two antenna elements (32, 34, 36, 38), and that
the received vectorial signals are evaluated and processed by means of at least one receiving circuit (70), in particular an LF (low-frequency) receiving circuit, so that the angular position of the at least one object is also measured and determined.

8. The method according to claim 7, characterized in that
the received analog broadband signals
are filtered and/or integrated, and particularly narrowed in bandwidth by means of at least one low pass filter unit (72a, 74a, 76a, 78a) connected after the I (inphase) output connection of the I/Q mixing unit (62, 64, 66, 68) and by means of at least one low pass filter unit (72b, 74b, 76b, 78b) connected after the Q (quadrature) output connection of the I/Q mixing unit (62, 64, 66, 68) and
are converted with a relatively low scan rate into digital signals by means of at least one AND (analog/digital) converter unit (82a, 82b, 84a, 84b, 86a, 86b, 88a, 88b), which is connected after the respective low pass filter unit (72a, 72b, 74a, 74b, 76a, 76b, 78a, 78b), and that
the digital signals, which are systematized in the form of complex-valued vectors or complex-valued scalars, are digitally processed by means of at least one processor unit (90), in particular microprocessor unit, connected after the A/D converter units (82a, 82b, 84a, 84b, 86a, 86b, 88a, 88b).

9. The method according to claim 7, characterized in that at least one MX (multiplex) unit (28), which is connected between the pulse delay unit (24) and the respective received pulse switch unit (52, 54, 56, 58), selectively triggers the respective received pulse switch units (52, 54, 56, 58), particularly in chronological order, with the time-delayed clock pulses, when the respective received pulse switch unit (52, 54, 56, 58) between the respective antenna element (32, 34, 36, 38) and the respective I/Q mixing unit (62, 64, 66, 68) is switched.

10. A use of at least one pulse radar apparatus (100) according to claim 1 and/or a method according to at claim 7 for measuring and determining the angular position of at least one object.
